(19) United States
(12) Patent Application Publication
(10) Pub. No.: US 2009/0061847 A1
(43) Pub. Date: Mar. 5, 2009

(54) MOBILE RADIO COMMUNICATIONS DEVICE AND METHOD OF CONTROL

(75) Inventor: Michael Roberts, Berkshire (GB)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/162,274

(22) PCT Filed: Jan. 11, 2007
(86) PCT No.: PCT/JP2007/050637

§ 371 Date: Jul. 25, 2008

(30) Foreign Application Priority Data
Jan. 26, 2006 (GB) 0601591.1

(51) Int. Cl. H04W 24/00

(52) U.S. Cl. 455/423

(57) ABSTRACT

The present invention provides for a mobile radio communications device arranged for communication by way of a mobile radio communications network, and by way of one of a plurality of frequencies, the mobile radio communications device having control means arranged to allow for a period of inter-frequency measurement within the device, wherein the mobile radio communication device is arranged to determine the said period of inter-frequency measurement in a manner responsive to higher layer events within the mobile radio communications device and which higher layer events can comprise application layer events.

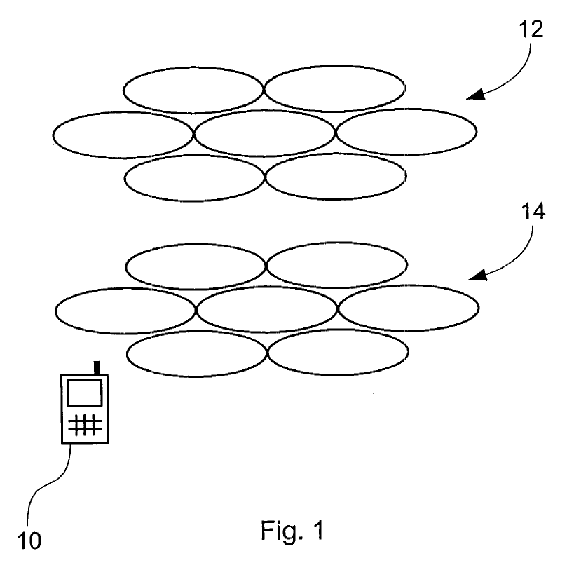

The present invention relates to a mobile radio communications device, and to a method of controlling the device, to allow for inter-frequency or inter Radio Access Technology (RAT) measurements.

Increasingly, mobile radio communications networks such as Wide Band Code Division Multiple Access (WBCDMA) networks are required to provide for discrete types of service. For example an R99 service can be required employing dedicated channels for packet switched and circuit switched communication sessions whilst also requiring the provision of Rel5 services in which dedicated generals are provided for circuit switched communication whereas High Speed Download Packet Access (HSDPA) can be required for packet switched communication. Of course, in order to provide for both levels of service within the network, typical network configurations make the R99 service available at one frequency, while HSDPA services are made available at another frequency.

The location of these different services and different frequencies represents a problem with regard to Radio Resource Measurement (RRM) since all User Equipment (UE) handsets will generally be camped on a single generic layer. Thus, if it is assumed that the current layer supports R99 services, the allocation of radio resources for R99 user equipment handsets can be achieved relatively easily and quickly. However, UE handsets requiring Rel5 bearer services suffer the disadvantage that when packet switched services are required there is first the need to allocate R99 bearers (within the layer the call is initiated), and then a subsequent handover procedure is required, as soon as possible, to the other layers. In order to achieve the handover to the other layers quickly and efficiently, and also in a secure, i.e. accurate, manner, the UE handset is required to perform inter-frequency measurements in order that the network can make an optimised choice of cell and radio resource.

The time taken to achieve such a reliable inter-frequency measurement therefore becomes a limiting factor that governs the channel-mode switching time of the network. Any decrease in reliability of the inter-frequency measurements, leads to a disadvantageous increase in the channel mode switching time offered by the network.

Also inter-frequency measurements are not made continuously when the UE handset is in either IDLE, CELL PCH or URA PCH, radio resource control states so as, primarily, to limit power consumption and therefore extend the battery life of the handset. Also inter-frequency and inter-RAT measurements are generally only made when the quality of service falls below a specified level. In any case, the period of time for which inter-frequency and inter-RAT measurements are provided is relatively small so as to save battery resources. In this manner, the probability that inter-frequency or inter-RAT measurements are available at the same time as when a mobile originating packet is to be sent, or a mobile originating call is to be made, is relatively small and, in practice, such measurements are not available to be sent to the network.

Though it might be thought to be possible to delay call set-up times in order to allow inter-frequency/inter-RAT measurements, this is only available for certain background services, such as short messaging systems services although at the front end, the user nevertheless still experiences disadvantageous limitations associated with such implementations.

In general, the requirements of limiting power-consumption and for offering an appropriate period of frequency measurement are in direct opposition to each other. Thus, in order that channel switching to the HSDPA layer can be made relatively quickly, there is a need for a trade-off between inter-frequency measurements and battery life, in particular in relation to Mobile Originating (MO) calls.

The present invention seeks to provide for a mobile radio communications device, and method of control thereof, and which exhibit advantages over known such devices and methods.

In particular, the invention seeks to provide for a mobile radio communications device allowing for inter-frequency measurements to be made even when within IDLE, CELL PCH or URA PCH modes.

According to a first aspect of the present invention there is provided a mobile radio communications device arranged for communication by way of a mobile radio communications network, and by way of one of a plurality of frequencies, the mobile radio communications device having control means arranged to allow for a period of inter-frequency measurement within the device, wherein the mobile radio communications device is arranged to determine the said period of inter-frequency measurement in a manner responsive to higher layer events within the device.

The present invention can advantageously provide for a mobile radio communications device that can continue to offer inter-frequency measurements in scenarios where in the current art, such measurements would not continue. However, the period for which such measurements continue nevertheless can be restricted in some manner related to the particular mode of operation of the mobile radio communications device so as to advantageously limit power consumption.

Preferably, a plurality of frequencies which are to be subject to the inter-frequency measurement are provided within system information delivered to the mobile radio communications device handset.

Alternatively, the said indication of the plurality of frequencies can be provided from the mobile radio communications network.

Advantageously, the inter-frequency measurements can comprise inter-RAT measurements.

In particular, the device can be arranged to provide for inter-frequency measurements when in at least one of the CELL PCH, URA PCH or IDLE modes.

Advantageously, the device is arranged to receive an indication of the period for which the measurement is to be continued from the network.

Yet further, the period for which the measurements is to continue can be controlled responsive to the previous behaviour pattern of the user of the mobile radio communications device.

Advantageously, the said events comprise application-layer events.

Further, the said events can comprise user-initiated events.

In one particular embodiment, the mobile radio communications device is arranged to provide for the said measurements prior to a communication session originated by the device.

According to another aspect of the present invention, there is provided a method of operating a mobile radio communications device by way of a mobile radio communications network, and by way of a plurality of frequencies, the method including the step of controlling a period of inter-frequency measurement within the device in a manner responsive to higher layer events within the device.

Advantageously, the method includes the step of providing the frequencies to be subject to the inter-frequency measurement within the system information.

Alternatively, the frequency values to be subject to the inter-frequency measurement can be provided from the network.

Preferably, the method can include the step of providing inter-frequency measurements in the form of inter-radio access technology measurements.

In particular, the inter-frequency measurements can be provided when in at least one of a CELL PCH, URA PCH or IDLE mode.

As a further feature, the period for which the inter-frequency measurement is to be performed can itself be provided from the network.

Alternatively; the period for which the inter-frequency measurements is to be performed can be determined from the behaviour of the user.

In particular, within the above-mentioned method, the said higher layer events can comprise application-layer events.

Yet further, the said events can comprise user-initiated events.

Of course, it should be appreciated that the method can be provided prior to a communication session initiated by the mobile radio communications device.

The present invention can therefore provide for an arrangement for standardising user-equipment procedures to allow for inter-frequency (inter-RAT) measurement reporting to the network so as to provide for approved support for radio resource management in particular in relation to a UMTS Terrestrial Radio Access Network (UTRAN) for Mobile Originating (MO) calls.

By way of the present invention, it becomes readily possible to expand the manner within which inter-frequency measurements can be provided. Thus, having ensured the possibility of the power-efficient provision of such inter-frequency measurements, the advantages associated in providing different frequencies that can be measured in the manner of the present invention can be further enhanced.

For example, HSDPA resources are allocated in a generally fixed manner, usually in blocks of five codes, and in order to allow for the speedy allocation of HSDPA traffic.

In view of this, it can prove problematic to mix the dynamics of a R99 allocation to be fixed HSDPA allocation, such that the placement of HSDPA resources within another frequency band advantageously allows for the partitioning of resources.

The provision of the HSDPA resources within another frequency band in this manner can therefore be better served by way of the present invention and which enhances the manner in which inter-frequency measurements can be provided between those two or more frequency plans.

Further, the power control for R99 and Rel5 HSDPA is markedly different and so allowing for the separation of such services proves to be advantageous insofar as it can serve to minimise any service interoperability problems or interference. The provision of efficient inter-frequency measurements can therefore advantageously readily allow for the separation of these service levels so as to prevent such interoperability problems and interference.

Yet further, while network operators may seek to deploy two frequencies anticipating the use of HSDPA services, the deployment of HSDPA services in, for example, both collocated Node B services can prove an expensive solution. Insofar as the present invention allows for the ready availability of inter-frequency measurements, the need to provide HSDPA services within both collocated Node B arrangements can therefore readily be avoided.

Also, for the provision of Multimedia Broadcast Multicast Services (MBMS) generally require sources similar to HSDPA and so it will often be attractive to seek to operate a frequency conversion scheme to the HSDPA/MBMS layer. The present invention can advantageously facilitate such operations.

The invention is described further hereinafter by way of example only with reference to the accompanying drawing which represents schematic representation of a mobile radio communications device arranged for use with different layer services in accordance with an embodiment of the present invention.

Turning to the FIGURE, there is illustrated user equipment 10 in the form of a mobile radio communication device handset and which arranged for access to both a plurality of cells 12 of a first layer of R99 DCH and HSDPA services available at a frequency X, and a further plurality of cells 14 of a second layer of R99 DCH services within a frequency Y.

In this manner, it should be appreciated that the network can be arranged to send frequency X signals for the HSDPA service.

Within the illustrated embodiment, it should be appreciated that the handset 10 is in IDLE mode and is camped on the R99 DCH layer. The handset 10 nevertheless receives from the network the frequency and cell identities of the R99 and HSDPA layers.

It should be appreciated that the measurements could also comprise inter-RAT cell or WiFi measurements.

Again, within the illustrated embodiment, the user equipment handset 10 can include an indication that if it; supports HSDPA, then it will pre-prepare measurement on a given frequency layer or cell.

In accordance with the present invention, when the user equipment handset 10 identifies occurrence of a higher layer event such as an application layer event wherein the mobile handset 10 detects an activity from the relevant application layer, inter-frequency measurements can be made.

Such application layer activity can, for example, comprise, the user selecting the SMS screen for a packet switched service, or the user opening a browser for a packet switched service, or the user starting to make a circuit switched call etc.

Once such an appropriate higher layer event has been identified, the user equipment handset 10 can start to initiate measurement of the frequency/cell(s) that are indicated by the network as being preferred for a particular type of service. When the mobile finally initiates the call, these measurements can be given to the network and the network can then perform the handover immediately to the selected frequency/cell(s).

Also, when the user equipment handset 10 transits from a CELL DCH/CELL FACH mode to a CELL PCH or URA PCH or IDLE mode, the user equipment handset 10 can for a time continue to measure the frequency/cell(s) in order to cater for the possibility that there may be a returning packet or call that can be received.

Such behaviour is illustrated further below.

If the user is called, or calls some other party, i.e. a transition from an IDLE state to a CELL DCH state, and the quality is inappropriate, the user hangs up so as to return from a CELL DCH to an IDLE state such that the user device handset can again make an inter-frequency measurement, and subsequently attempt a transition from an IDLE to a CELL DCH state. The network can then perform the inter-frequency handover as required.

Similarly, assuming the user acts to download pages from the Internet, there will be a transition from the IDLE to the CELL DCH R99 state and while the user reads a page, the network can place the mobile in CELL PCH or URA PCH state wherein the mobile continues to provide for frequency measurements. Also the user can continue to down-load a further page such that there is a transition from the CELL PCH/URA PCH to CELL DCH modes within the handset and the network can be arranged to connect the mobile radio communications device to the HSDPA layer.

The time for which the user device handset 10 can be arranged to continue to provide for inter-frequency/cell measurements can be determined directly from the network, and either provided explicitly to the user device handset, or broadcast within the system information. Alternatively, such a period can be determined by the past behaviour of the handset as determined by the particular user. For example, if, after launching the browser, it is found that the user typically checks emails immediately, or say within 30 seconds, the device can select 30 seconds as the optimum time period that it should provide for inter-frequency measurements. Alternatively, it may be arranged to defer measurements for ten seconds and only measure inter-frequency/cell(s) after that initial ten-second period to mirror specific behavioural patterns of the user.

As will be appreciated, the present invention seeks to provide for advantages as compared with the current art and such that the handset can autonomously continue to provide for inter-frequency measurements when, for example, in CELL PCH, URA PCH and IDLE modes. Further, the time period for which the mobile radio communications device performs such functionality can be determined on the basis of events that it receives, and knowledge passed to it, from applications that are running at higher levels within the handset such as screen-activity levels within the device handset. After the determined period has expired, the device is arranged to stop performing any such inter-frequency measurements in order to prolong battery life.

Advantageously, the list, or range, of frequencies/cell(s) that the mobile radio communications device should preferably measure can be provided to the handset within the system information. Alternatively, this information can be provided to the handset by the network, depending upon the different types of transport mechanisms (bearers) supported by the network, such as R99 DCH; EDGE; HSDPA; EDCH, or other types of RABs that are activated.

The events at the higher level that can trigger the inter-frequency measurement can be determined by particular applications that have been triggered by the user such as SMS, POC, browser, SKYPE etc. For example, assuming the user starts to use a circuit switched call, the mobile radio communications device can then perform inter-frequency cell measurements for frequencies that support R99 services. In this case, after the user has completed dialing the number, the mobile radio communications device then has enough time to make reliable inter-frequency measurements for the network such that the network is then able to perform channel type switching simultaneously at the moment that the call is initiated.

The present invention is therefore advantageous insofar as the network can be arranged to provide to the mobile radio communications device the frequency/cell(s) on which specific services will be present.

The mobile radio communications device can use the indication of such frequency/cell(s) in order to make appropriate measurements before a call is made, or triggered, by the application, or by user behaviour.

As noted, the mobile radio communications device may be guided by the network, or receive specific indication, with regard to the length of time within which the measurements need to occur.

In this manner, the present invention allows the extension of inter-frequency, such as inter-RAT, measurements in a manner immediately responsive to the particular manner/mode of operation of the mobile radio communication device, so as to increase the likelihood of the inter-frequency measurement data being available, while maintaining power supply life-time.

1. A mobile radio communications device arranged for communication by way of a mobile radio communications network, and by way of one of a plurality of frequencies, the mobile radio communications device having control means arranged to allow for a period of inter-frequency measurement within the device, wherein the mobile radio communications device is arranged to determine the said period of inter-frequency measurement in a manner responsive to higher layer events within the device.

2. A device as claimed in claim 1 and arranged such that an indication of the plurality of frequencies which are to be subject to the inter-frequency measurement are received within system information delivered to the device.

3. A device as claimed in claim 1 and arranged such that the indication of the plurality of frequencies is received from the mobile radio communications network.

4. A device as claimed in claim 1, 2 or 3, wherein the inter-frequency measurements can comprise inter-RAT measurements.

5. A device as claimed in any one or more of claims 1 to 4 and arranged to provide for inter-frequency measurements when in at least one of the CELL PCH, URA PCH and IDLE modes.

6. A device as claimed in any one or more of the preceding claims and arranged to receive an indication of the period for which the measurement is to continue from the network.

7. A device as claimed in any one or more of claims 1 to 5, and arranged such that the period for which the measurements continue can be controlled responsive to a previous behavioural pattern of the device user.

8. A device as claimed in any one or more of the preceding claims wherein the higher layer event comprises an application-layer event.

9. A device as claimed in any one or more of the preceding claims wherein the higher layer event comprises a user-initiated event.

10. A method of operating a mobile radio communications device by way of a mobile radio communications network, and by way of a plurality of frequencies, the method including the step of controlling a period of inter-frequency measurement within the device in a manner responsive to higher layer events within the device.

11. A method as claimed in claim 10 and including the step of providing an indication of the frequencies to be subject to the inter-frequency measurement within system information.

12. A method as claimed in claim 10 and including the step of providing an indication of the frequencies to be subject to the inter-frequency measurement from the network.

13. A method as claimed in claim 10, 11 or 12, and including the step of providing inter-frequency measurements in the form of inter-RAT measurements.

14. A method as claimed in claim 10, 11, 12 or 13, wherein the inter-frequency measurements are provided when in at least one of a CELL PCH, URA PCH and IDLE mode.

15. A method as claimed in any one or more of claims 10 to 14, wherein the period for which the inter-frequency measurement is performed is provided from the network.

16. A method as claimed in any one or more of claims 10 to 14, wherein the period for which the inter-frequency measurements are to be performed is determined from past behaviour of the user.

17. A method as claimed in any one or more of claims 10 to 16, wherein the said higher layer events comprise application-layer events.

18. A method as claimed in any one or more of claims 10 to 17, wherein the said events comprise user-initiated events.

19. A mobile radio communication device arranged for communication by way of a mobile radio communications network and substantially as hereinbefore described with reference to the accompanying drawing.

20. A method of operating a mobile radio communications device by way of a mobile radio communications network, and substantially as hereinbefore described with reference to, as illustrated in, the accompanying drawing.
